(19) United States
(12) Patent Application Publication
(10) Pub. No.: US 2008/0301992 A1
(43) Pub. Date: Dec. 11, 2008

(54) Benchmark-ing hallmark-ing quick-change-ing photo and print display

(76) Inventors: Terry Lee Wagenknecht, Rockford, IL (US); Samuel James Wagenknecht, Rockford, IL (US); Charles Maxwell Wagenknecht, Rockford, IL (US)

Correspondence Address: TERRY LEE WAGENKNECHT, 6693 HEATHER LANE, ROCKFORD, IL, 61114, US

(21) Appl. No.: 12/228,120

(22) Filed: Aug. 8, 2008

Related U.S. Application Data
(63) Continuation-in-part of application No. 10/812,332, filed on Mar. 29, 2004.

(51) Int. Cl. G09F 7/18

(52) U.S. Cl. 40/658

(57) ABSTRACT

A changeable photo or print display with optional stand is formed from a single substrate of an at least slightly flexible cardstock, paperboard, plastic or magnetic sheeting with no resulting knock-out parts, crimps or sharp bends required for its manufacture via high speed print and cut methods, and having at least one or more appendage forming inverted U-shape through cut slits with tension releasing and tear preventative beginning and ending points being directed inwardly and upwardly; and with other embodiments having a plurality of concentrically smaller and centeredly located appendages which form a stand as two laterally extending tabs of an interiorly located appendage abut and support a rearward surface of a larger surrounding indicia sheet retaining appendage to form a slight strengthening curvature to further secure the standing display and held photo or print; and with any rearwardly extending appendages or resulting apertures being hidden from a frontal viewer by the held photo as it is retained between a frontward surface of a largest appendage and a rearward surface of the surrounding substrate body.

### CROSS-REFERENCE TO RELATED APPLICATIONS

This disclosure is a continuation in part of application Ser. No. 10/812,332, filed Mar. 29, 2004 and is hereby incorporated by reference in its entirety.

### STATEMENT REGARDING FEDERALLY SPONSORED RESEARCH OR DEVELOPMENT

Not applicable.

### REFERENCE TO SEQUENCE LISTING

Not applicable.

### FIELD OF THE INVENTION

The present invention relates to a changeable photo and print display formed from one single substrate requiring no interiorly located knock-out parts or crimps or weakened hinge bend lines for high speed print and cut methods.

### DESCRIPTION OF PRIOR ART

Previous single substrate changeable print displays which require no interiorly located knock-out parts or crimps in their formation, and which utilize at least one or more appendage forming inverted generally U-shape or V-shape through cut slits with inwardly or inwardly and upwardly directioned beginning and ending points to permit an indicia sheet to be fully and completely inserted downwardly between the appendage and the surrounding substrate body, and wherein specific beginning and ending directions of the slit simultaneously prevents a further tearing of the slit itself were not found in any prior art. Without the specially directed beginning and ending points, a thicker indicia sheet may not be fully inserted between the appendage and surrounding substrate; as the thickness of the substrate itself, or the thickness of the indicia sheet prevents a full and complete downward insertion due to overly pinched areas at and near a slits beginning and ending points. Neither did prior art address or disclose a plurality of concentrically centered and smaller appendages for a users option of forming a stand wherein the retained indicia conceals any resulting apertures.

### SUMMARY

A changeable print display is specifically designed for manufacture via high speed print and cut methods by including at least one or more centeredly located, inverted generally U-shape or V-shape through cut slit(s) and resulting appendage(s) which retain an indicia sheet between a frontward surface of an appendage and a rearward surface of the surrounding substrate body. The slit(s) includes chamferred corners and inwardly and upwardly directed beginning and ending points which permit an indicia sheet to be completely inserted to a vertically lowest location where a slit first extends laterally inward. The combined inwardly and upwardly directed beginning and ending points simultaneously prevent a further tearing of the slit itself from the beginning and ending points to or toward the perimeter edge of the body or inwardly toward or within the appendage. The substrate may be of most any material which is at least slightly flexible, and including paper cardstock, plastic or magnetic sheeting. Alternative embodiments include a slight display strengthening curvature to further aid a retention of the indicia sheet; or may also comprise the original or largest appendage having one or more appendage forming slits which are reduced in size and centeredly located within the largest appendage to form a series of consecutively smaller indicia display openings and their surrounding substrates; and wherein any smaller size appendage therein may be inverted 180 degrees in its orientation to give the user an option of inverting the entire display accordingly to the users situation. The inwardly and upwardly directed beginning and ending points result in tear resistant tabs which may pivot upward to abut a larger surrounding appendage to form a slight display strengthening curvature while simultaneously supporting an interiorly located appendage which forms a stand. The plurality of interiorly located appendages of the optionally invertable display provides an end user multiple choices in using the appendages to form the stand. There are no requirements of knockout parts or sharp bend lines or crimped bend lines in the manufacturing or use or assembly of the display to achieve either a retention of an indicia sheet or a strengthening curvature or the optional self standing function. Any rearwardly extending appendages or resulting apertures are totally hidden from a frontal viewer by the indicia sheet.

### OBJECTS AND ADVANTAGES

It is a first object of this invention to release tensions at and near the beginning and ending points of a displays vertically inverted generally U-shape or V-shape appendage which is formed via a single through cut slit; and by forming the inverted generally U-shape or V-shape slit with beginning and ending points which are first directed inwardly.

The foremost advantage of this first object is a release of overly pinched areas of tension at and near the beginning and ending locations of the inverted U-shape or V-shape slit; and wherein a sheet of paper or plastic indicia may be completely and fully inserted to the most lowest vertical position where the beginning and ending points of the slit extend inwardly.

A second advantage of the inwardly directions of the beginning and ending points is to prevent the slit from extending outwardly to or further toward the substrates perimeter edge.

It is a second object of this invention to further release the same areas of pinched tension and to further prevent a tearing of the slit in an inwardly direction toward or into the body of the appendage itself by further directing the beginning and ending points in an upwardly direction.

The advantages of the second object are a further release of pinched tension to facilitate a thicker indicia sheet, and a further prevention of a tearing of the slit in an inwardly direction or toward or into the body of the appendage.

The inwardly and upwardly directions of the beginning and ending points result in generally semi-circular shape tabs. A combined advantage of the first two objects is the cooperative buffering and release of tension at and near the two generally semi-circular shape tabs; and with an additional resulting advantage of an overall prevention of any further tearing of the slit in two directions simultaneously; and while the substrate is being operated in a normal fashion by pulling the upper edge of the body away from the appendage to insert or remove indicia sheets of various thicknesses. Not all printed matter is as thin as a sheet of paper. Gift cards are about the thickness of a credit card or drivers license, and may be fully and completely inserted to the most lowest portion where the beginning and ending points of the slit first extend inwardly.

It is a third object of this invention that the display is in a slightly curved shape; and either laterally curved or vertically curved, and with the direction of any curvature being chosen by the manufacturer pending the substrate material type, overall size, thickness, flexibility, and the type of indicia sheet to be retained, and the end purpose of the entire display. All descriptions of a slightly curved display in either a lateral curvature or a vertical curvature shall define a display which is not completely flat or planar in both directions at once, and in example; a glass surface; and within nominal dimensions of curvature being defined as a curved display having a variance from a completely planar surface of 1/32 inch or preferably more.

It is also part of the third object to either factory heat form a plastic display in a lateral curvature form, or for and end user to compress by hand or to compress and retain a plastic substrate display by any means chosen by the end user to form a plastic display substrate and its appendage(s) in a slight lateral curvature to better retain the indicia sheet in its vertically uppermost areas; and particularly when the substrate is used outdoors as a changeable golf sponsor display.

It is also part of the third object for an end user to optionally take advantage of any existing previously described generally semi-circular shape tabs which apply pressure against a rearward surface of an appendage to achieve a slight curvature of a display.

The advantages of any lateral or vertical curvatures within the third object is to more pinchingly and better retain the indicia sheet at and near the sheets vertically uppermost areas between the appendage and surrounding substrate. Thicker and more rigid substrate displays such as those made of 0.060 to 0.080 inch polystyrene will better retain an indicia sheet with a slight lateral curvature in its vertically uppermost areas; and whereas smaller sized displays of about 8 inches or less in height, and using thinner and less rigid substrates such as 12 point poster card stock or 0.060 magnetic sheeting will also better retain an indicia sheet with any slight curvature, and whether lateral or vertical, or in combination.

It is a fourth object of this invention to include at least one or more additional and centeredly located inverted U-shape slit(s) with the same specially directed beginning and ending points and resulting tabs; and wherein each additional resulting appendage is consecutively smaller in size than the first appendage.

The advantage of the fourth object is for a user to optionally place a smaller size indicia sheet within the same display, or to place the same size sheet in front of a smaller size appendage to reveal more of the displays printed surface, and in example; to reveal more surface area of the pentagons within a soccer ball image display for a viewer to better recognize the overall soccer ball theme.

It is a fifth object of this invention to invert at least one of the interiorly located additional slit(s) and its resulting appendage(s) 180 degrees in its orientation.

The advantage of the fifth object can be seen when the display is used for a walkathon, and wherein the display has a directional arrow printed on the surface which surrounds the original and largest appendage; and wherein the entire display may be directionally inverted to synchronize the arrow with the direction or path in which the participants are to go. The very same indicia sheet may be removed from the largest appendage, and then be placed between an interiorly located and previously inverted appendage and its surrounding substrate to identify the particular walkathon.

It is a sixth object of this invention to form the display from a single substrate without requiring any interiorly located knock-out parts in its diecut forming.

There are multiple advantages of the sixth object, and including a faster and more efficient production when diecutting a paperboard display on a high speed printing or cylindrical diecutting press without a need for a machine or a human worker having to deal with fallen away knock-out parts. Additionally, when diecutting a larger display from an easily scoreable material such as 0.060 polystyrene, the cut may be partially through the material, and wherein the manufacturer or the end user may finish any partially cut through slits by bending the substrate until the material self scores completely through the displays body; and wherein the display will remain in a more rigid and one piece transportable planar state until its initial assembly or use.

It is a seventh object of this invention to permit a user to optionally take advantage of the previously described and interiorly located appendages and their surrounding substrate material(s), and which may also include a previously described 180 degree inverted slit(s) and any resulting appendage(s); and

wherein the user pulls any number of the stated consecutively smaller size appendages in an outwardly, rearwardly, and downwardly direction to form a stand for the original and largest appendage and its surrounding main body.

The advantage of the seventh object is for a user to optionally use the already existing appendage(s) and the material surrounding the appendage(s) to form a stand for the entire display. The stand function is formable by hand when a display is of either paperboard or most any type of flexible plastics; as no sharp bends are required due to the buffering and tension releasing effect, and the tear preventive features of the inwardly and upwardly beginning and ending point directions and the resulting tabs of the appendage forming slit(s). Portions of the display at and near the generally semi-circular shape tabs are both tension free, and tear resistant. There are two ways to form a stand without forming any sharp bends. The most interiorly located appendage may be shifted or pivoted upward to abut the indicia sheet itself; and when the entire display is about 4 by 5 inches in size. The next larger and interiorly located appendage will slant rearward and downward to abut the surface of a table to form the stand. Another embodiment includes a tab at the apex of the innermost V-shape appendage which is received by a slot or slit located centeredly near the lower perimeter edge of the displays main body; or is received by a notch centeredly located within the lower perimeter edge of the display.

It is an eighth object of this invention to alter the resulting generally semi-circular shape tabs by extending their shapes in a slightly outward direction from the generally U-shape or V-shape of the inverted through cut slit. As an end user optionally forms a stand as in the seventh object, the laterally extended tabs of the interiorly located appendage will pivot and shift vertically upward to abut and apply pressure upon the rearward side of the largest appendage which surrounds the laterally extended tabbed appendage.

The advantage of the eighth object is for the semi-circular shape tabs to pressure the largest appendage in a forwardly direction to better retain the fully inserted sheet of indicia between the frontward surface of the largest appendage and the rearward surface of the main body. In this position, the tabs place enough pressure upon the surrounding appendage to achieve a previously described slight curvature within most of the entire display, and both before and after an indicia sheet is fully inserted.

Further advantages of the eighth object may be clearly seen when the display is formed of a magnetic sheeting substrate, and wherein the material may be any thickness from 0.020 inch thick to 0.060 or more. The properties of a rubbery type of magnetic sheet which is laminated with a very thin film of vinyl sheeting on one surface include its tendency to self score in any direction via the smallest scratch or nick. When pinched between a users fingers, or when a crimped bend line is imposed on the material, it will fracture completely through; and so any sharp bends for forming an optional stand are not possible. The tension free areas of the stress distributing and tear preventive generally semi-circular shaped tabs will permit an end user to optionally form a stand without requiring or forming any sharp bends which would normally fracture the magnetic sheeting. Advantages of the sixth object of no knock-out parts will also especially be seen when diecutting any magnetic sheeting, as any knock-out parts would not fall away, but would cling to the magnetic sheeting and interfere with its travel through a continuous web process of die-cutting.

It is a ninth object of this invention as partially and previously described, to have a tab receiving slot or slit or notch near or at the most vertically lowest area of the perimeter edge of the display to receive any tabulated shape of any interiorly located appendage; yet the notch or slit is preferred to retain a display which is formable without any knock-out parts.

The advantage of the ninth object is to use the same cut through slit format and shape for either forming a display from a floppy 0.060 magnetic sheet of material, or floppy 10 point card stock, or from a more rigid 14 point poster card stock; and wherein once the tabulated portion is engaged, one display will stand at exactly the same degree of angle as the next, and will not be dependent on the type of substrate which is used for the entire display.

It is a tenth object of this invention to have intermittent areas of no through cutting within the inverted slit(s) path.

The advantage of the tenth object is a faster diecutting process by preventing any appendage parts from curling away from the main body in their travel through a web type diecutting process. The entire display will remain in a more rigid planar state until the end user makes a final punch out of the appendages by hand; and being simular to a paper doll punching. This embodiment may be best suited for a post card type of substrate being anywhere between 12 points thick and up to 14 points thick, and also for magnetic sheeting.

It is an eleventh object of this invention to require no machine formed or crimped weakened hinge bend line areas within any part of the displays manufacturing; and especially when thicker paper or magnetic sheeting or plastic substrates of 14 points thickness or more are used.

The advantage of the eleventh object is to completely remove any sharp bending or crimping process; and wherein the display is completely formable with one downstroke of a high speed diecutting machine; and wherein both the multiple appendages and the tear preventive generally semi-circular tabbed portions will facilitate a stand to be formed via a gentle curving instead of any sharp bends. This advantage does not deny an end user the option of forming their own sharp bends by hand within any particular type of display substrate, and other than a magnetic sheeting substrate.

It is a twelfth object of this invention to more securely retain a gift card within the largest indicia opening, or to the largest appendage by having an angled slit within each corner of the largest appendage; or to include elongate tabulated portions within the body of the display; or invertedly, a notch being within the cut line of the appendage, and being just vertically above the largest appendage and centeredly extending vertically downward into the uppermost portion of the largest appendage. Other embodiments may include a plurality of notches, or one at each lateral side of the inverted U-shape appendage.

The advantage of the elongate tabulated portion(s) and the angled slits is to better retain a gift card in a commercial business environment where the card retaining display may be dropped to the floor or tossed into a shopping cart.

It is a final object of this invention for the manufacturer to have the option of forming a display with most any perimeter edge shape they choose; and while not affecting any function of any interiorly located appendages.

The advantages of the final object are easily seen in the drawings using a semi-circular shape perimeter; and wherein the entire background of the display may be a full color detailed photo of a soccer ball, base ball, basket ball, etc. The end uses of this display extend to many large and diverse targeted markets, and including greeting cards, sports photo displays, benchmarkers, hallmarkers, directional signage, point of purchase gift card sales, calling card holders, refrigerator magnet photo holders, and most any market with a need for a changeable indicia display where an end user may additionally and optionally form a stand from the already existing interiorly located appendage(s).

In summation, there are no indicia displays with a self enclosed stand which are now on the market that can be die-cut from one single substrate, and which do not require any knock-out parts or sharp bends in the displays manufacturing, assembly or use; and especially no displays which give the end user an option of forming a stand which requires no sharp bends for forming a magnetic display, and particularly where the stand does not leave an aperture viewable by the user after a photo or any indicia is inserted. The very same refrigerator magnet display will show no apertures before or after it is assembled to be self standing. Combined advantages of all the previous objects of intent cooperate to produce a quick changing display with multiple options for the end user; while providing a manufacturer the use of high speed print and cut methods for forming a cost effective multi-purpose quick changing photo, print, and indicia display.

### NUMERALS IN DRAWINGS

20 A main body surrounding the appendage.

21. An angled U-shape through cut slit.

22 An inverted U-shape through cut slit.

23 An inverted V-shape through cut slit.

24 An indicia sheet retaining slit formed appendage.

25 An inwardly directed beginning and ending point of the slit.

26 An inwardly and upwardly directed beginning and ending point of the slit.

27 A location of pinching when no inwardly or inwardly and upwardly directed beginning and ending points exist.

28 A chamferred portion of the inverted U-shape cut through slit.

29 An area of vertical sheet displacement represented by two arrows.

30 A smaller sized slit formed appendage located within a larger appendage.

31. A tab of a smallest size interiorly located appendage being intermediate the cut lines beginning and ending point locations.

32 A vertically inverted slit formed appendage.

33 A tab formed by the inwardly and upwardly directed beginning and ending

42 points.

34 A flat indicia sheet substrate.

35. A notch type of indent within the cut line of an appendage.

36 An at least minimally curved portion of the display.

37. An intermittent portion or gap within a through cut line.

38 A plurality of interiorly located appendages.

39 A tab receiving notch formed within the lower perimeter edge of the body.

40 A tab receiving slot formed near the lower perimeter edge of the body.

41 A portion of tab 33 which extends laterally outward.

42 A tab receiving slit formed near the lower perimeter edge of the body.

### DESCRIPTION OF THE PREFERRED EMBODIMENT

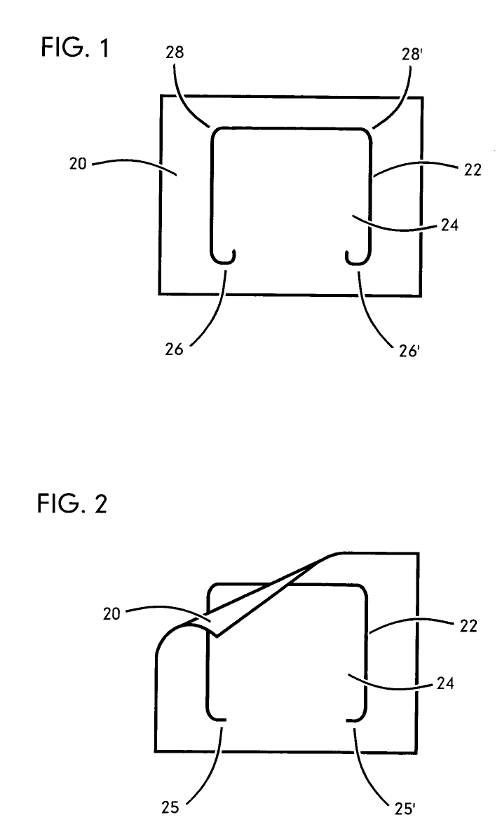

The preferred embodiment in FIG. 1 comprises a main body (20) surrounding an inverted U-shape through cut slit (22) and a resulting indicia sheet retaining appendage (24) with two inwardly and upwardly directed beginning and ending points (26), and two chamferred portions (28) at the vertically upper corners of the inverted U-shape cut through slit (22).

### BRIEF DESCRIPTION OF THE DRAWINGS

FIG. 1 shows a frontal view of the preferred embodiment.

FIG. 2 shows a frontal view of an alternative embodiment with inwardly directed beginning and ending point locations, and with an upper portion of the main body pulled toward the viewer and away from the appendage and prior to inserting a sheet of indicia paper.

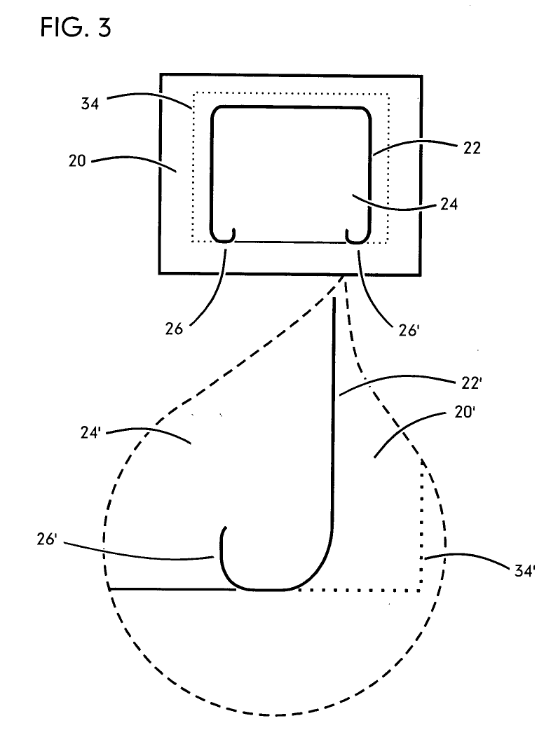

FIG. 3 shows a frontal view of the preferred embodiment after a sheet of indicia paper is fully inserted, and also including a zoomed in view of the lowermost portion of the paper sheet.

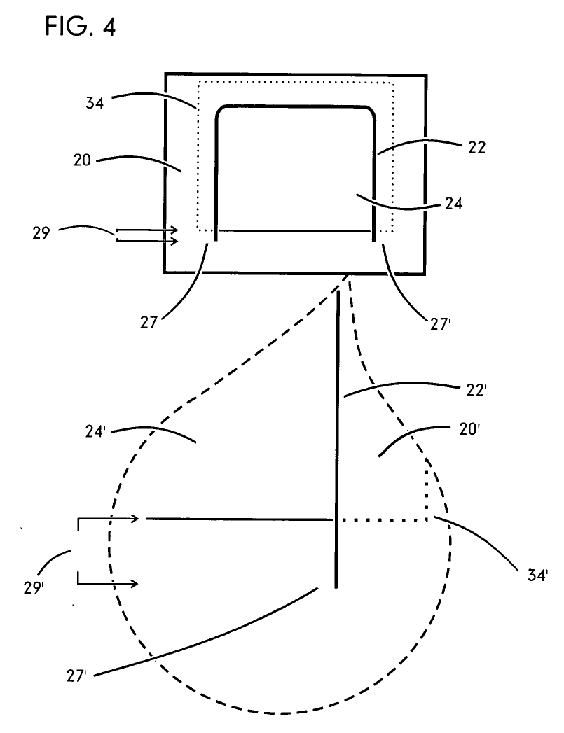

FIG. 4 shows a frontal view of a prior art display which does not include specially directed beginning and ending points of the inverted U-shape appendage, and also including a zoomed in view of the lowermost portion of the paper sheet.

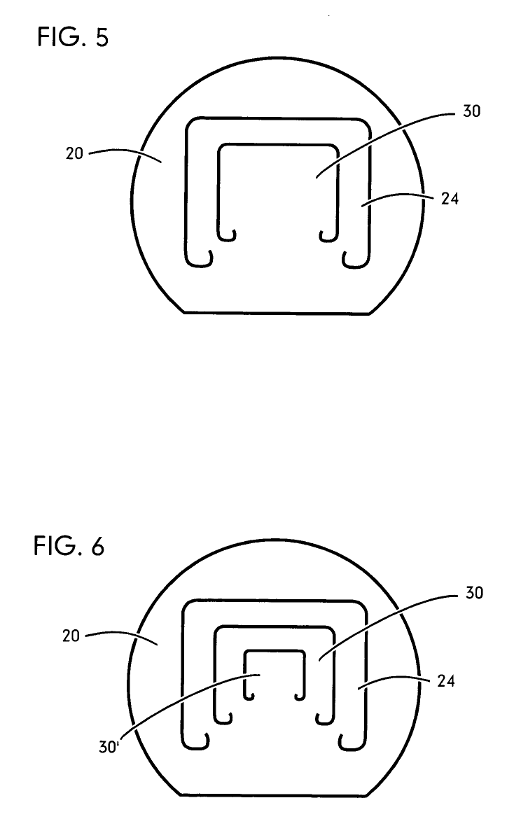

FIG. 5 shows a frontal view including an additional and smaller size appendage centeredly located within the largest appendage.

FIG. 6 shows a frontal view including multiple and consecutively smaller size appendages centeredly located within the largest appendage.

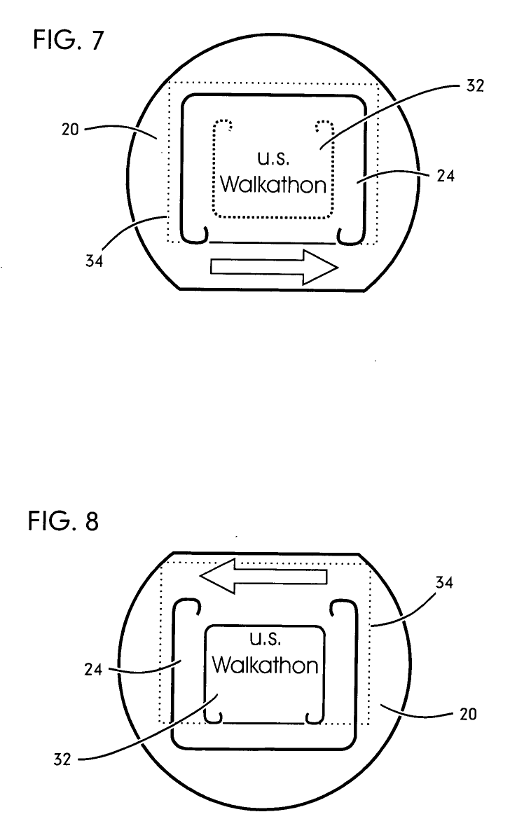

FIG. 7 shows a frontal view of two appendages with the innermost appendage being inverted 180 degrees, and with a directional arrow printed on the main body of the display, and including a printed indicia example sheet fully inserted within the largest opening of the display.

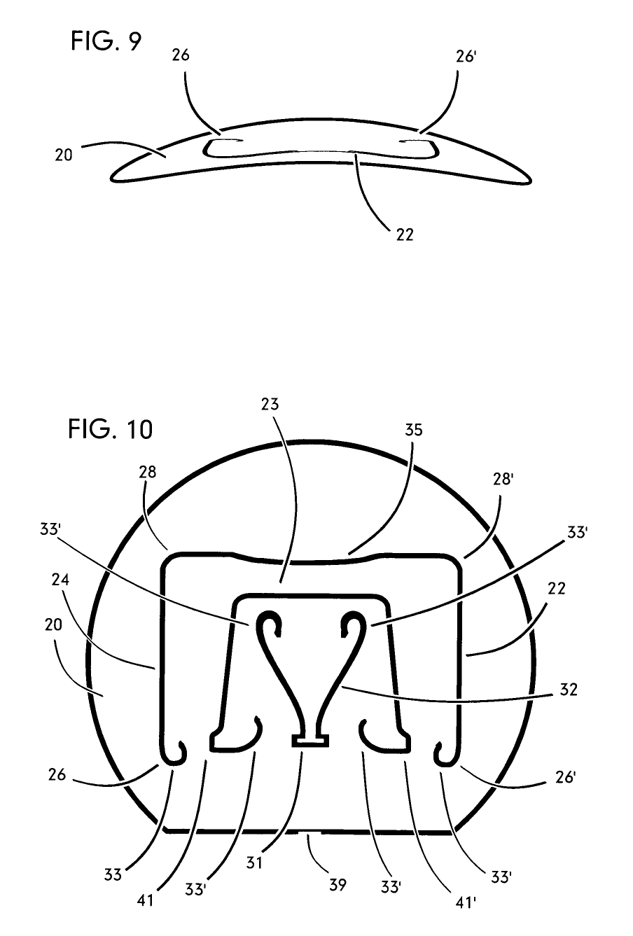

FIG. 8 shows a frontal view of the display of FIG. 7 inverted 180 degrees, and including the same printed indicia example sheet of FIG. 7 fully inserted within the smaller sized inverted opening of the display.

FIG. 9 shows a slightly perspective overhead view of a display including a slight lateral curve.

FIG. 10 shows a frontal view of an alternative embodiment with multiple appendages.

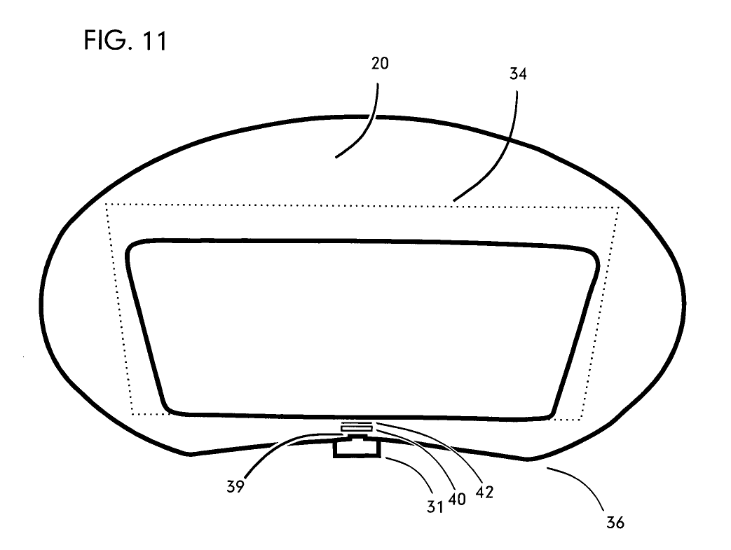

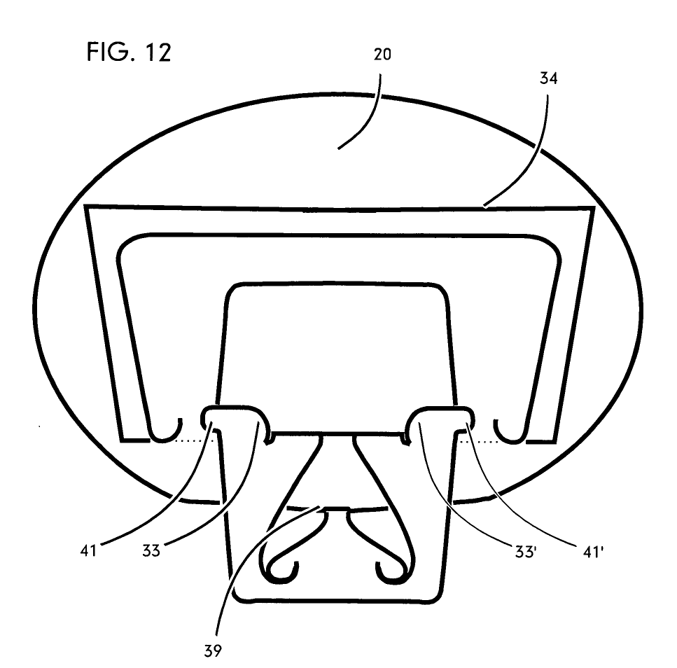

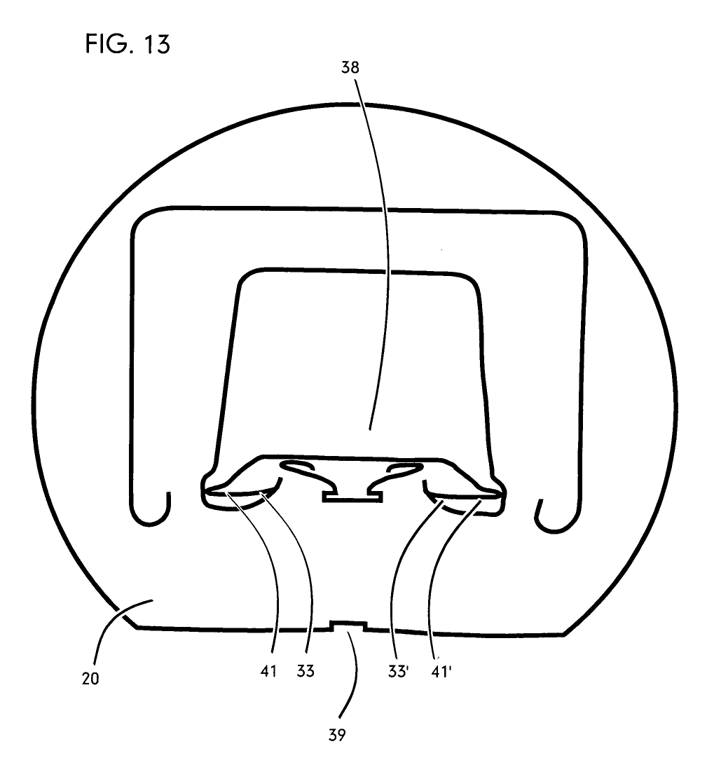

FIG. 11 is a frontal overhead perspective view at an angle of about 45 degrees with an inserted indicia sheet.

FIG. 12 is a rearward overhead perspective view at an angle of about 45 degrees which views the body of the display with an inserted indicia sheet.

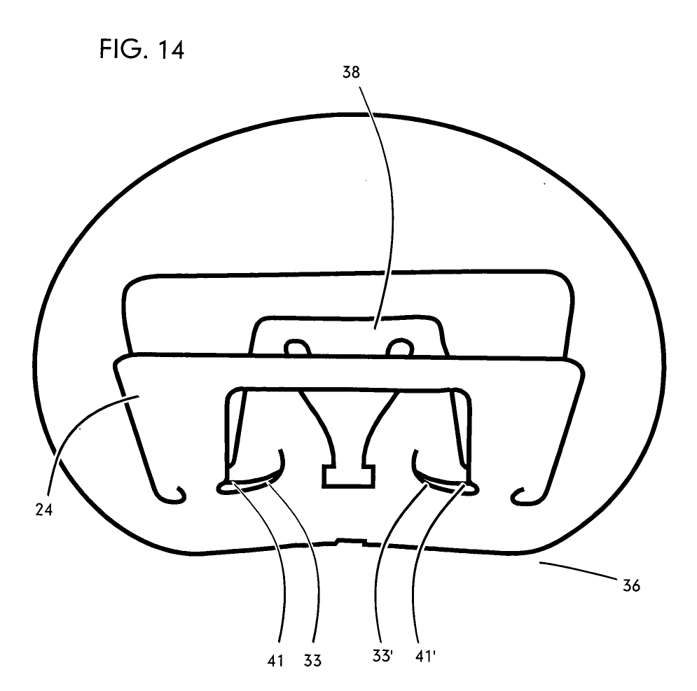

FIG. 13 is a frontal view with the two innermost appendages angled rearward and away from the viewer.

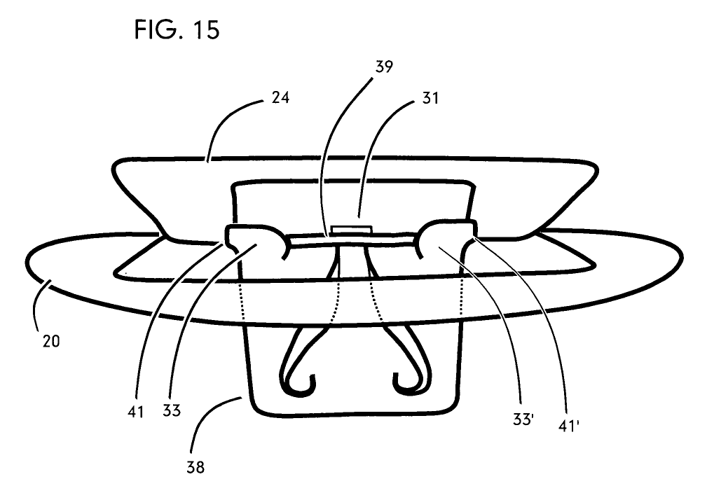

FIG. 14 is a frontal perspective view with the largest and indicia retaining appendage angled toward the viewer.

FIG. 15 is an overhead view with the largest and indicia retaining appendage angled outwardly and away from the body.

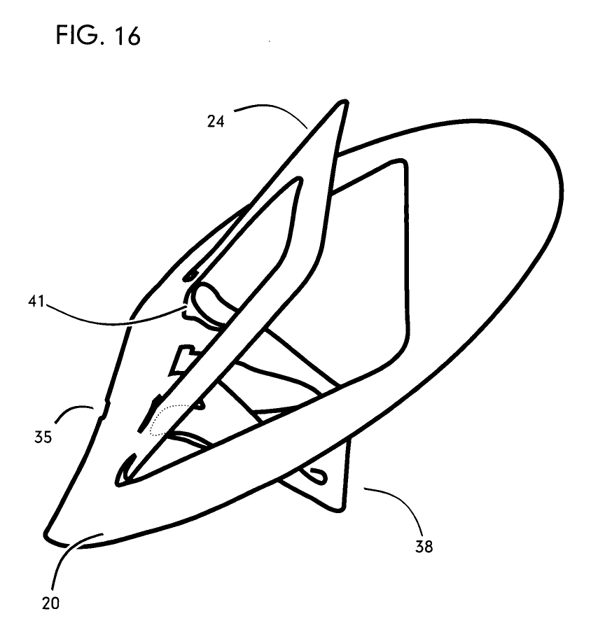

FIG. 16 is an overhead side perspective view with the largest and indicia retaining appendage angled outwardly and away from the body.

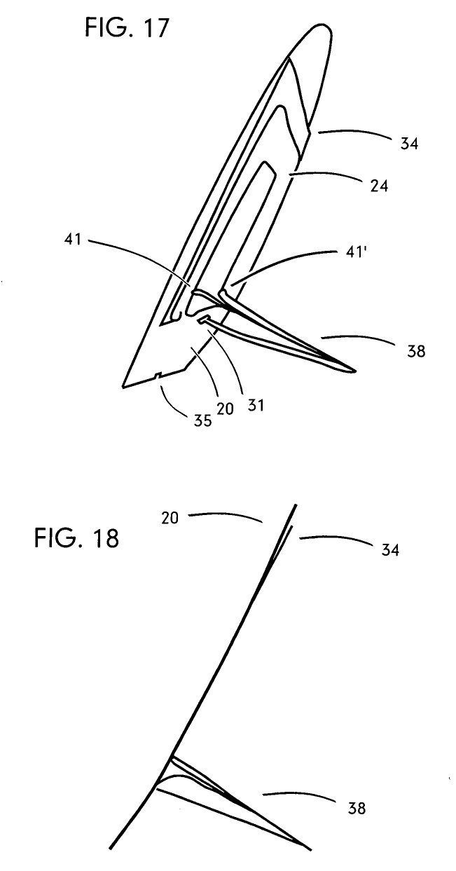

FIG. 17 is a side perspective table view shown with indicia sheet inserted.

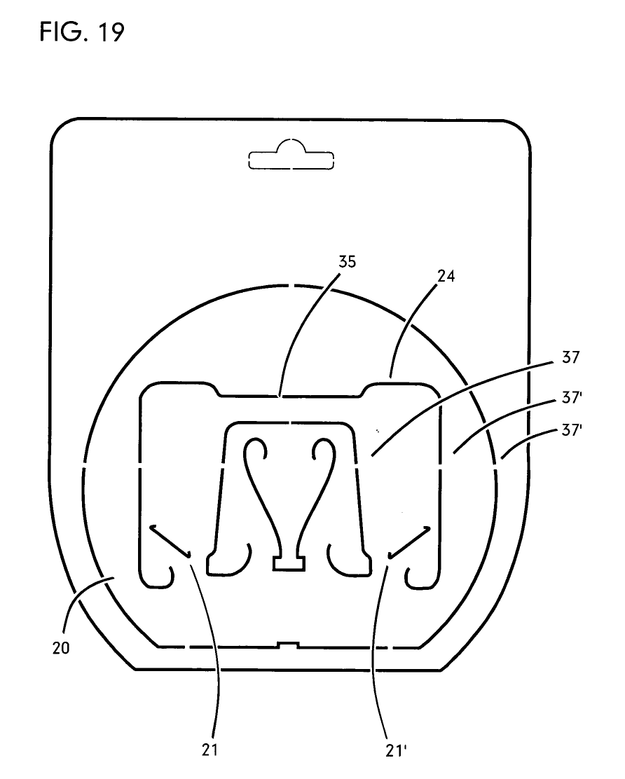

FIG. 18 is a straight on table side view of FIG. 17.

FIG. 19 is a front view of the display shown formed as one unit within a point of purchase gift card hanger.

### DETAILED DESCRIPTION OF THE DRAWINGS

FIG. 1 shows a frontal view of the preferred embodiment comprising a main body (20)surrounding an inverted U-shape through cut slit (22) and a resulting indicia sheet retaining appendage (24) with two inwardly and upwardly directed beginning and ending points (26), and two chamferred portions (28) of the inverted U-shape through cut slit.

FIG. 2 shows a frontal view of an alternative embodiment with inwardly directed beginning and ending point locations (25), and with an upper portion of the main body (20) pulled toward the viewer and away from the slit formed appendage (24), and prior to inserting a sheet of indicia paper, and showing the inverted U-shape through cut slit (22).

FIG. 3 shows a frontal view of the preferred embodiment after a sheet of indicia paper (34) is fully inserted between the surrounding body (20) and the appendage (24), and also including a zoomed in view of where the lowermost portion of the paper sheet is positioned at the portion of the inwardly and upwardly directed beginning and ending point (26) locations where the slit (22) first extends laterally inward.

FIG. 4 shows a frontal view of a prior art display which does not include specially directed beginning and ending points of the inverted U-shape appendage (24), and also including a zoomed in view of the lowermost portion of a flat indicia sheet (34), and locations of pinching (27) when no inwardly and upwardly directed beginning and ending points exist, and which results in an area of vertical sheet displacement (29). Also shown is the main body (20) surrounding the appendage (24), which is created by the inverted U-shape through cut slit (22).

FIG. 5 shows a frontal view including an additional and smaller size appendage (30) centeredly located within the largest appendage (24) surrounded by the main body portion (20).

FIG. 6 shows a frontal view including multiple and consecutively smaller size appendages (30) centeredly located within the largest appendage (24), and the main body portion (20).

FIG. 7 shows a frontal view of two appendages (24), (32) similar to FIG. 5, but with the innermost appendage (32) being inverted 180 degrees, and with a directional arrow printed on the main body (20) of the display, and including a printed indicia example sheet fully inserted within the largest opening of the display.

FIG. 8 shows a frontal view of FIG. 7 with the displays surrounding body (20) being inverted 180 degrees, and including the same printed indicia example sheet (34) of FIG. 7 fully inserted within the smaller sized inverted opening. Also shown are the same two appendages (24) and (32) of FIG. 7.

FIG. 9 shows an overhead view of a display including a slight lateral curve, and showing the two inwardly and upwardly directed beginning and ending points (26) of the inverted U-shape slit (22), and the displays body (20).

FIG. 10 shows a frontal view of an alternative embodiment comprising a main body (20) surrounding a first inverted U-shape through cut slit (22) and two chamferred portions (28) and a resulting indicia sheet retaining appendage (24), and having an indented notch (35) within the slits cut line, and with the slit having two inwardly and upwardly directed beginning and ending points (26), which form tabs (33). A smaller sized slit formed first V-shape appendage (23) centeredly located within the first and larger U-shape appendage. The V-shape appendage has two tabs (33) with portions that extend laterally outward (41). Another and second inverted V-shape appendage is again inverted and centeredly located within the first inverted V-shape appendage. The second V-shape appendage also has two tabs (33) at its cut lines beginning and ending point locations, and has a third tab (31) located intermediate the beginning and ending point locations. Also shown is a notch (39) within the lower perimeter edge of the substrate body.

FIG. 11 is a frontal overhead perspective view at an angle of about 45 degrees which views the body (20) of the display having a slight lateral curve (36), and showing the inserted indicia sheet (34), and a tab receiving notch (39) formed within the lower perimeter edge of the body, and a tab (31) of a smallest size interiorly located appendage extending toward the viewer and secured within the notch, and an at least minimally curved portion of the display (36), and also a tab receiving slot (40) or slit (42) formed near the lower perimeter edge of the body.

FIG. 12 is a rearward overhead perspective view at an angle of about 45 degrees which views the body (20) of the display showing the inserted indicia sheet (34), and a tab receiving notch (39) location formed within the lower perimeter edge of the body. An interiorly located inverted V-shape appendage has two tabs (33) with portions that extend laterally outward (41).

FIG. 13 is a frontal view with the two innermost appendages (38) angled rearward and away from the viewer, and showing the laterally extended portions (41) of the tabs (33) of the largest of the two innermost appendages, and a tab receiving notch (39) location formed within the lower perimeter edge of the body (20). Note a lack of minimal curvature.

FIG. 14 is a frontal perspective view with the largest and indicia retaining appendage (24) angled toward the viewer, and with the two innermost appendages (38) angled rearward and away from the viewer, and showing the laterally extended portions (41) of the tabs (33) just abutting the rearward surface of the indicia retaining appendage, but before they pivot upwardly, as the two innermost appendages (38) are angled rearwardly, but not yet downwardly. Also note the resulting minimal curvature (36).

FIG. 15 is an overhead view with the largest and indicia retaining appendage (24) angled outwardly and away from the body (20), and with the two innermost appendages (38) angled rearward and downwardly, and showing the laterally extended portions (41) abutting and locked against the rearward surface of the indicia retaining appendage (24) after the tabs (33) have pivoted upwardly, and showing the tab receiving notch (39) location which is formed within the lower perimeter edge of the body (20), and a tab (31) of a smallest size interiorly located appendage secured within the notch, and with the notch not being seen by the viewer within this overhead view. Minimal curvature cannot be seen in this view, but is still there.

FIG. 16 is an overhead side perspective view with the largest and indicia retaining appendage (24) angled outwardly and away from the body (20), and with the two innermost appendages (38) angled rearward and downwardly, and with only one laterally extended portion (41) abutting against the rearward surface of the indicia retaining appendage (24), and with no interlocking of a tabbed appendage within the notch (35), and showing the display standing with generally too much angle of about 45 degrees; yet still standing with no indicia sheet inserted.

FIG. 17 is a side perspective table view shown with the indicia sheet (34) fully inserted, and with both laterally extended portions (41) abutting against the rearward surface of the indicia retaining appendage (24), and with no interlocking of the tab (31) of the innermost appendage of the plurality of interiorly located appendages (38) within the notch (35), and showing the tab (31) abutting the rearward surface of the body (20), and with the display now standing at 27 degree slant after the indicia sheet has been inserted between the frontward surface of the appendage (24) and the rearward surface of the body (20).

FIG. 18 is a straight on table side view of FIG. 17 showing the body (20) and the indicia sheet (34) and a plurality of interiorly located appendages (38).

FIG. 19 is a front view of the display shown formed as one unit within a point of purchase gift card hanger, and showing intermittent portions (37) or gaps within the through cut lines, and showing angled U-shape through cut slits (21), and a notch type of indent (35) within the through cut line of the largest indicia retaining appendage (24), and the main surrounding portion of the body (20).

### OPERATION

In forming the display, the reader may refer to the drawings for a fairly accurate representation, as almost all drawings are superimposed line art renditions of electronic photos taken of actual prototypes.

The changeable indicia displays body FIG. 1, (20) may be formed from most any substrate including paper, cardstock, cardboard, thin metals, magnetic sheeting, or plastic sheets such as polystyrene, polyethylene, polypropylene, polyurethane, etc., and only requiring that the substrate is at least slightly flexible near and surrounding the inverted U-shape (22) or V-shape (23) through cut slit.

The display may be formed by hand-cutting, machine die-cutting or stamping. If a thicker and more 3-D like display is desired, the substrate may be plastic injection molded to achieve any detailed depths or raised portions of the displays front surface.

FIG. 1 shows a frontal view of the preferred embodiment comprising a main body (20) surrounding an inverted U-shape through cut slit (22) and a resulting indicia sheet retaining appendage (24) with two inwardly and upwardly directed beginning and ending points (26), and two chamferred portions (28) of the inverted U-shape cut through slit. The two chamferred portions are not required, but are preferred for an aesthetic looking rectangle with rounded corners. All drawings show a horizontal rectangular shape indicia window, yet this disclosure does not eliminate the concept of a vertical rectangular shape indicia window.

When forming the display from a very thin substrate such as a mailing type of post card which is about 6 or 8 points thick, the manufacturer may choose to form the alternative embodiment with only the inwardly directed beginning and ending points (25) as in FIG. 2 which shows a frontal view of an alternative embodiment with inwardly directed beginning and ending point locations (25), and with an upper portion of the main body (20) pulled toward the viewer and away from the slit formed appendage (24), and prior to inserting a sheet of indicia paper, and showing the inverted U-shape through cut slit (22). Since the substrate is so extremely thin, there still will be no amount of vertical sheet displacement represented by two arrows as shown in FIG. 4, (29) when inserting an average thickness of photo print or sheet of indicia paper, and so the indicia sheet will still be inserted fully and completely downward to the location where the beginning and ending points FIG. 2, (25) are first directed inwardly. This embodiment may not receive a thicker indicia print such as a plastic credit card or gift card or an even thicker substrate without having at least some of the area of vertical sheet displacement which is shown being represented by two arrows as shown in FIG. 4, (29), but will still be fully and downwardly insertable when the indicia substrate comprises a standard paper thickness.

When including both inwardly and upwardly directed beginning and ending points within a through cut slit line, a much thicker sheet of indicia sheet may be inserted fully and completely downward to a location where the slit first extends laterally inward, and as shown in FIG. 3.

FIG. 3 shows a frontal view of the preferred embodiment after a sheet of indicia paper (34) is fully inserted between the surrounding body (20) and the appendage (24), and also including a zoomed in view of where the lowermost portion of the paper sheet is positioned at the portion of the inwardly and upwardly directed beginning and ending point (26) locations where the slit (22) first extends laterally inward.

When a display includes the inverted U-shape through cut slit without any inwardly or inwardly and upwardly directed beginning and ending points, there will be at least some amount of vertical sheet displacement as shown in FIG. 4.

FIG. 4 shows a frontal view of a prior art display which does not include specially directed beginning and ending points of the inverted U-shape appendage (24), and also including a zoomed in view of the lowermost portion of a flat indicia sheet (34), and locations of pinching (27) when no inwardly and upwardly directed beginning and ending points exist, and which results in an area of vertical sheet displacement (29). Also shown is the main body (20) surrounding the appendage (24), which is created by the inverted U-shape through cut slit (22).

The exact amount of vertical displacement co-depends on both the thickness and type of material used for both the indicia substrate sheet and the display.

An alternative embodiment having two appendages, and so two indicia display windows is shown in FIG. 5, and showing a frontal view including an additional and smaller size appendage (30) centeredly located within the largest appendage (24) surrounded by the main body portion (20).

An alternative embodiment having three appendages is shown in FIG. 6, and is showing a frontal view including multiple and consecutively smaller size appendages (30) centeredly located within the largest appendage (24), and the main body portion (20).

The alternative embodiment of FIG. 7 shows a frontal view including two appendages (24), (32), and is similar to FIG. 5, but with the innermost appendage being inverted 180 degrees, and with a directional arrow printed on the main body (20) of the display, and including a printed indicia example sheet fully inserted within the largest opening of the display.

As described in the objects and advantages section of this disclosure; one advantage of inverting any interiorly located appendage can be seen when the display is used for a walkathon, and wherein the display has a directional arrow printed on the surface which surrounds the original and largest appendage; and wherein the entire display may be directionally inverted to synchronize the arrow with the direction or path in which the participants are to go. The very same indicia sheet may be removed from the largest appendage, and then be placed between an interiorly located and previously inverted appendage and its surrounding substrate to identify the particular walkathon.

FIG. 8 shows a frontal view of FIG. 7 with the displays surrounding body (20) being inverted 180 degrees, and including the same printed indicia example sheet (34) of FIG. 7 fully inserted within the smaller sized inverted opening. Also shown are the same two appendages (24) and (32) of FIG. 7. Materials used for this larger type of display may include many different types of plastics such as 0.060 styrene or polypropylene, or a 4 mil corrugated plastic.

Any embodiment of this invention, and including all alternative embodiments, and all type of substrate materials may include a slight curvature within any part of the substrates body to further strengthen a standing display, and to more securely retain an indicia sheet, and especially in the vertically uppermost areas of the display.

Curvature within any portion of the display may be formed by the end user by hand forming, or pivoting tabs, or interlocking tabs within tab receiving apertures or notches; or by the manufacturer in heat forming a plastic substrate display, or predetermining a length of any interiorly located appendages to apply pressure against portions of the display when the appendages are extended downwardly and or inwardly to abut any rearward portion of the display.

The means for forming any minimal curvature or significant curvature are infinite in quantity, and so are not claimed in detail within this disclosure as to the means for achieving any curvature; but only that any curvature at all will at least add to the strength, or the standing strength of the display, and will at least further aid the indicia substrate to be more securely retained.

As described in the objects and advantages section; the display may be in a slightly curved shape; and either laterally curved or vertically curved, or in combination, and with the direction of any curvature being chosen by the manufacturer pending the substrate material type, overall size, thickness, flexibility, and the type of indicia sheet to be retained, and accordingly to the end purpose of the entire display. All descriptions of a slightly curved display in either a lateral curvature or a vertical curvature shall define a display which is not completely flat or planar in both directions at once, and in example; a glass surface; and within nominal dimensions of curvature being defined as a curved display having a variance from a completely planar surface of 1/32 inch or preferably more.

One example of a significant amount of curvature is shown in FIG. 9, and showing an overhead view of a display including a slight lateral curve, and showing the two inwardly and upwardly directed beginning and ending points (26) of the inverted U-shape slit (22), and the displays body (20).

Curvature is not numbered in all the drawings after FIG. 9, but can be clearly seen by the viewer throughout the electronic camera induced drawings which were previously described as superimposed line art renditions of electronic photos taken of actual prototypes.

An alternative embodiment having a total of three appendages, and with notch and tab portions located within the through cut line of the slits is shown in FIG. 10.

FIG. 10 shows a frontal view of an alternative embodiment comprising a main body (20) surrounding a first inverted U-shape through cut slit (22) and two chamferred portions (28) and a resulting indicia sheet retaining appendage (24), and having an indented notch (35) within the slits cut line, and with the slit having two inwardly and upwardly directed beginning and ending points (26), which form tabs (33). A smaller sized slit formed first V-shape appendage (23) centeredly located within the first and larger U-shape appendage. The V-shape appendage has two tabs (33) with portions that extend laterally outward (41). Another and second inverted V-shape appendage is again inverted and centeredly located within the first inverted V-shape appendage. The second V-shape appendage also has two tabs (33) at its cut lines beginning and ending point locations, and has a third tab (31) located intermediate the beginning and ending point locations. Also shown is a notch (39) within the lower perimeter edge of the substrate body.

FIGS. 11 through 18 relate to the embodiment depicted within FIG. 10, and with any variations being minimal, and only concerning an optional tab receiving slot (40) or an angled U-shape through cut slit (21). All other figures are to show the reader different views and various ways to optionally form a stand and to further reinforce the display by applying minimal curvature to the display by using the already existing multiple appendages.

An alternative embodiment with an added slot is shown in FIG. 11; and where FIG. 11 is a frontal overhead perspective view at an angle of about 45 degrees which views the body (20) of the display having a slight lateral curve (36), and showing the inserted indicia sheet (34), and a tab receiving notch (39) formed within the lower perimeter edge of the body, and a tab (31) of a smallest size interiorly located appendage extending toward the viewer and secured within the notch, and a slight curvature (36), and also showing an optional tab receiving slot (40) or slit (42) formed near the lower perimeter edge of the body.

The slotted embodiment is not intended for manufacturing within a high speed print and cut process, but more pertains to larger outdoor displays such as a golf tournament hole sponsor sign using a thicker plastic material, and where any slot near the lower portion of the body will be hidden by grass or turf.

FIG. 12 is a rearward overhead perspective view at an angle of about 45 degrees which views the body (20) of the display showing the inserted indicia sheet (34), and a tab receiving notch (39) location formed within the lower perimeter edge of the body. An interiorly located inverted V-shape appendage has two tabs (33) with portions that extend laterally outward (41). Minimal curvature at the lower edge of the body is not numbered, but is still viewable by the reader.

FIG. 13 is a frontal view with the two innermost appendages (38) angled rearward and away from the viewer, and showing the laterally extended portions (41) of the tabs (33) of the largest of the two innermost appendages, and a tab receiving notch (39) location formed within the lower perimeter edge of the body (20). Note how the extended portions (41) are not abutting the rearward surface of the largest appendage, and how there is no visible curvature at the lower portion of the display body.

FIG. 14 is a frontal perspective view with the largest and indicia retaining appendage (24) angled toward the viewer, being similar to FIG. 13, and with the two innermost appendages (38) angled rearward and away from the viewer, and showing the laterally extended portions (41) of the tabs (33) just abutting the rearward surface of the indicia retaining appendage, but before they pivot upwardly, as the two innermost appendages (38) are angled rearwardly, but not yet downwardly. Note how a minimal curvature (36) is now formed at the lower edge of the display body by the extended portions (41) which now abut the indicia retaining appendage (24).

FIG. 15 is an overhead view with the largest and indicia retaining appendage (24) angled outwardly and away from the body (20), and with the two innermost appendages (38) angled rearward and downwardly, and showing the laterally extended portions (41) abutting and locked against the rearward surface of the indicia retaining appendage (24) after the tabs (33) have pivoted upwardly, and showing the tab receiving notch (39) location which is formed within the lower perimeter edge of the body (20), and a tab (31) of a smallest size interiorly located appendage secured within the notch, and with the notch not being seen by the viewer within this overhead view. Minimal curvature cannot be seen in this view, but is still there.

FIG. 16 is to show the reader how the display is able to still stand without any tabular interlocking or without both extended portions (41) being in place against the retaining appendage (24), and with FIG. 16 showing an overhead side perspective view with the largest and indicia retaining appendage (24) angled outwardly and away from the body (20), and with the two innermost appendages (38) angled rearward and downwardly, and with only one laterally extended portion (41) abutting against the rearward surface of the indicia retaining appendage (24), and with no interlocking of a tabbed appendage within the notch (35), and showing the display standing with generally too much angle of about 40 degrees; yet still standing with no indicia sheet inserted.

FIG. 17 is to show the reader how the degree of slant is changed by simply applying both extended portions (41) in their correct position, and how the angle is affected even more by the insertion of an indicia sheet to alter the amount of angle the display will stand at.

Shown in FIG. 17, is a side perspective table view with the indicia sheet (34) fully inserted, and with both laterally extended portions (41) abutting against the rearward surface of the indicia retaining appendage (24), and with no interlocking of the tab (31) of the innermost appendage of the plurality of interiorly located appendages (38) within the notch (35), and showing the tab (31) abutting the rearward surface of the body (20), and with the display now standing at a 27 degree slant after the indicia sheet has been inserted between the frontward surface of the appendage (24) and the rearward surface of the body (20).

FIG. 18 is a straight on table side view of FIG. 17 showing the body (20) and the indicia sheet (34) and a plurality of appendages and their surrounding materials (38). This view is to better show the reader how the display can form its own stand as shown in FIG. 17, and how there is no absolute requirement of any interlocking tab, or notch or slot elements.

FIG. 19 is to show the reader a plurality of alternative embodiments which may include or not any of the elements shown; and including one of many end use purposed displays, wherein this embodiment is a gift card holder or promotional gift card display.

FIG. 19 is a front view of the display shown formed as one unit within a point of purchase gift card hanger, and showing intermittent portions (37) or gaps within the through cut lines, and showing angled U-shape through cut slits (21), and a notch type of indent (35) within the through cut line of the largest indicia retaining appendage (24), and showing the main surrounding portion of the display body (20).

A commercial electronic gift card may be held within the display by the indicia retaining appendage (24) when appropriately sized, but when the manufacturer intends to use the display as a promotional item to sell the gift card, the appendage (24) is best sized to hold a much larger photo or print, and wherein the notch type of indent (35) and the largest and indicia retaining appendage (24) and the angled U-shape slits (21) will help to retain the smaller sized standard gift card within the appendage (24). Any variation of angle or quantity of the U-shape slits (21) may be used without interfering with the displays end use function, as any slits within the appendage will be hidden by the end users retained photo or print.

### CONCLUSION, RAMIFICATIONS, AND SCOPE

Accordingly, the reader will see that the scope of this new Benchmark-ing Hallmark-ing Quick-Change-ing Photo And Print Display goes beyond it's many advantages over previous quick changing indicia displays.

The magnetic sheeting embodiment of this quick change display may either mark or designate a hallways steel doors, or a doorways surrounding steel encasement, or a steel bench for assigning temporary seating locations.

The very same magnetic sheeting embodiment may be alternatively used for marking or designating seating arrangements on a tables surface when the multiple existing appendages are optionally extended rearwardly and downwardly to form a stand for the quick changing display.

And accordingly, the reader will see the value of a display which requires no knock-out parts in its manufacture, and the value of no visible apertures within its frontal viewing surface, and the users option of forming a stand; and while yet the greatest value of this display may be the ability to insert various thicknesses of indicia sheets being insertable fully and completely downward.

Although the previous descriptions contain many specifics, these should not be construed as limiting the scope of the invention but as merely providing illustrations of the presently preferred embodiment and any alternative embodiments of this invention.

We claim:

1. a changeable indicia print display comprising;
an at least slightly flexible generally planar body,
wherein at least one or more inverted generally U-shape through cut slit(s) form at least one or more appendage(s),
wherein a beginning and ending points of said slit(s) are directed generally inwardly or inwardly and upwardly,
wherein said inwardly and upwardly beginning and ending points form tabs,
wherein said or more appendage(s) are approximately centeredly located being generally concentrically smaller in size,
wherein said at least one said appendage is defined as a first appendage,
whereas an improvement being portions at and or near said beginning and ending points are released of pinching tension,
wherein a substrate sheet is retained between a frontward surface of said first appendage and a rearward surface of said body,
and wherein said substrate sheet is inserted completely downward to a location where said slit(s) are first directed inwardly.

2. The display of claim 1;
wherein at least one said inverted generally U-shape through cut slit(s) is inverted 180 degrees in orientation.

3. The display of claim 2;
wherein said slit(s) includes a wider lateral dimension between said beginning and ending points to form a generally V-shape through cut slit(s).

4. The display of claim 1;
wherein portions of said slit(s) being adjacent said tabs extend laterally outward.

5. The display of claim 1;
wherein said appendage(s) comprises a tab being intermediate said beginning and ending points of said slit.

6. The display of claim 1;
wherein said appendage(s) comprises a notch being intermediate said beginning and ending points of said slit.

7. The display of claim 1;
wherein said body comprises a tab receiving notch or slot or slit at or near a lowermost perimeter edge of said body.

8. The display of claim 1;
wherein said first appendage surrounds a slit formed second appendage
wherein tabs of said second appendage pivot upwardly and forwardly to abut a rearward surface of said first appendage as said second appendage extends rearwardly and downwardly to form a stand.

9. The display of claim 8;
wherein portions of said slit(s) being adjacent said tabs extend laterally outward.

10. The display of claim 8;
wherein said second appendage surrounds a slit formed third appendage
wherein said third appendage extends approximately horizontal and forward to abut said body.

11. The display of claim 8;
wherein said second appendage surrounds a slit formed third appendage
wherein said third appendage extends approximately horizontal and forward to tabularly connect with said body.

12. The display of claim 1;
wherein a minimal curvature of said display further secures said substrate sheet and or said body.

13. The display of claim 1;
wherein said slightly flexible generally planar body element comprises plastic.

14. The display of claim 13;
wherein a heat formed said plastic results in a minimal curvature of said display to further secure said substrate sheet and or said body.

15. The display of claim 1;
wherein said slightly flexible generally planar body element comprises paperboard.

16. The display of claim 1;
wherein said slightly flexible generally planar body element comprises magnetic sheeting.

17. The display of claim 1;
wherein said slit(s) element is intermittent in continuity.

18. We claim;
a method for an indicia print display comprising;
an at least slightly flexible generally planar body,
wherein a first inverted generally U-shape through cut slit forms a first indicia retaining appendage,
wherein said first appendage surrounds a second inverted generally U-shape or inverted generally V-shape through cut slit to form a second appendage,
wherein said second appendage surrounds a third generally U-shape or V-shape through cut slit which forms a third appendage,
wherein a beginning and ending points of said slit(s) are directed generally inwardly or inwardly and upwardly,
wherein a substrate sheet is retained between a frontward surface of said first appendage and a rearward surface of said body,
wherein said first appendage and said second appendage form a stand,
whereas an improvement is a self standing changeable said display
wherein said substrate sheet conceals resulting apertures.

19. The display of claim 18;
wherein said body comprises a tab receiving element comprising a notch or slot or slit at or near a lowermost perimeter edge of said body.

20. The display of claim 18;
wherein said third appendage comprises a tab being intermediate said beginning and ending points of said slit.
